(19) United States
(12) Patent Application Publication
(10) Pub. No.: US 2016/0251046 A1
(43) Pub. Date: Sep. 1, 2016

(54) Motorcycle Engine Mount Having Improved Stiffness

(71) Applicant: Jeremy Ore, Santee, CA (US)

(72) Inventor: Jeremy Ore, Santee, CA (US)

(21) Appl. No.: 14/634,227

(22) Filed: Feb. 27, 2015

(51) Int. Cl. B62H 1/10; B62K 11/04

(52) U.S. Cl. CPC B62H 1/10; B62K 11/04

(57) ABSTRACT

A Motorcycle Engine Mount having Improved Stiffness. The device is a bolt-in replacement for the Original Equipment Manufacturer engine mounts for FXD_series Harley Davidson motorcycles. The device has a single-piece, hardened steel outer frame, and a interstitial formed from urethane (rather than rubber) having a durometer reading of 40-60. The outer frame and inner frame attachment elements are both formed with a plurality of apertures through them so that they will be infilled with urethane when the urethane is injected to form the interstitial element. This infilling will bond the three elements together for long-term durability. There are also front and rear retention plates made from hardened metal to further stabilize and bond the inner frame attachement element to the urethane interstitial element.

This application is filed within one year of, and claims priority to Provisional Application Ser. No. 61/945,493, filed Feb. 27, 2014.

### BACKGROUND OF THE INVENTION

1. Field of the Invention

This invention relates generally to motorcycle frame and mounting components and, more specifically, to a Motorcycle Engine Mount having Improved Stiffness.

2. Description of Related Art

The popularity of motorcycling continues to increase. Riders are attracted to the freedom of the open road, leaving behind the cares and worries of everyday life. Motorcycle manufacturers have seized upon the recent surge in popularity and continue to sell motorcycles and accessories in record numbers.

However, statistics show that motorcycles are generally more dangerous than automobiles. Two prior patents granted to Jake Ore (U.S. Pat. Nos. 7,967,097 and 8,387,737) address the issue with Harley Davidson¹ motorcycles commonly referred to as a “high-speed wobble” (or “tank-slapper”), which typically involves shaking or instability. This wobble can cause the front wheel can thrash from side to side in an uncomfortable and unsafe manner. The devices and methods of the '097 and '737 patents cured the high-speed wobble on the “FLH” series of Harley Davidson motorcycles (known as the “Electra Glide,” “Road King,” and “Ultra Classic). ¹ The Specification may include references to third-party trademarks, and copies of third-party copyrighted materials, which are the property of their respective owners, including H-D U.S.A., LLC. Reference to any product, process, publication, service, or offering by trade name, trademark or otherwise is not intended to constitute or imply the endorsement or recommendation of such by Harley-Davidson. “Wide Glide,” “Electra Glide,” and “Road King” trademarks are believed to be the property of H-D U.S.A., LLC.

It has been determined that two other models Harley Davidson—the “Wide Glide” and “Ultra Glide” (the “FXD_” series), suffer from a very similar problem. Because the FXD_series bikes employ a different mounting system as compared to the FLH series bikes, the two prior Ore devices were unable to solve the high speed wobble on these models of motorcycles.

Therefore, there remains a need to overcome the problem of instability in FXD_series HarleyDavidson motorcycles. The discussion of the background to the invention included herein is included to explain the context of the invention. This is not to be taken as an admission that any of the material referred to was published, known, or part of the common general knowledge at the priority date of the claims.

### SUMMARY OF THE INVENTION

In light of the aforementioned problems associated with the prior devices, it is an object of the present invention to provide a Motorcycle Engine Mount having Improved Stiffness. The device should be a bolt-in replacement for the Original Equipment Manufacturer engine mounts for FXD_series Harley Davidson motorcycles. The device should have a single-piece, hardened steel outer frame, and a interstitial formed from urethane (rather than rubber). The outer frame and inner frame attachment element should both be formed with a plurality of apertures through them so that they will be infilled with urethane when injected to form the interstitial element. This infilling will bond the three elements together for long-term durability. There should further be front and rear retention plates made from hardened metal to further stabilize and bond the inner frame attachement element to the urethane interstitial element.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of the Harley Davidson FXD_series frame and engine mount assembly²; ² Taken from the 2007 Harley Davidson Shop Manual; used for educational purposes only; all rights believed owned by Harley Davidson, Inc.

FIG. 2 is a front perspective view of the conventional engine mount element for an FXD_series motorcycle;

FIG. 3 is a rear perspective view of the engine mount element of FIG. 2;

FIG. 4 is a front perspective view a preferred embodiment of the engine mount element having improved stiffness of the present invention;

FIG. 5 is a rear perspective view of the element of FIG. 4;

FIG. 6 is a front perspective view of the engine attachment frame of the element of FIGS. 4 and 5;

FIG. 7 is a front perspective view of the frame attachment element and retention plates of the element of FIGS. 4 and 5; and

FIG. 8 is a flowchart depicting a preferred method of manufacture of the engine mount element of FIG. 4.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Motorcycle Engine Mount having Improved Stiffness³. ³ As used throughout this disclosure, element numbers enclosed in square brackets [ ] indicates that the referenced element is not shown in the instant drawing figure, but rather is displayed elsewhere in another drawing figure.

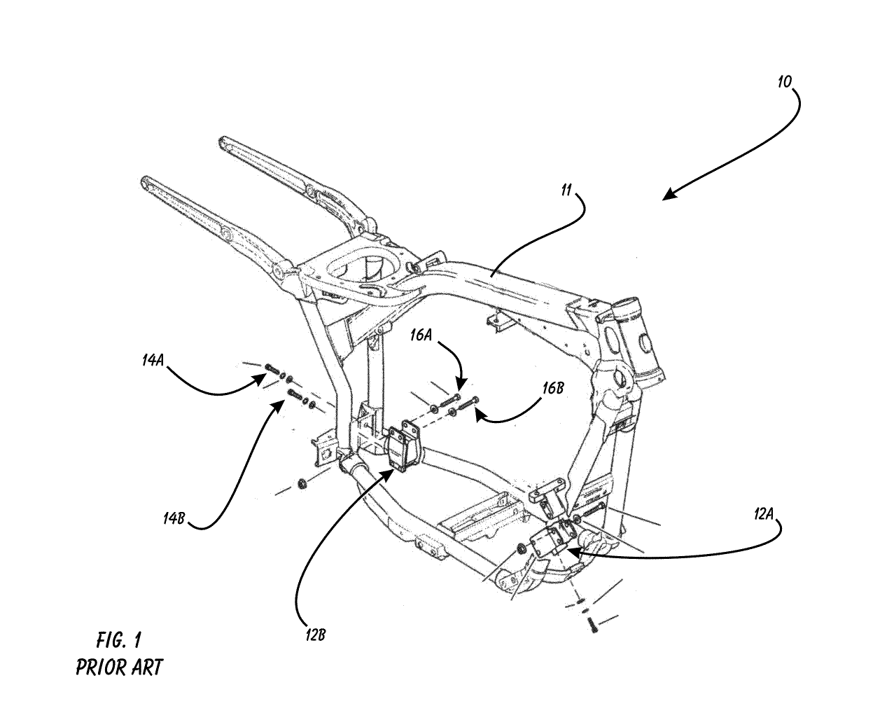

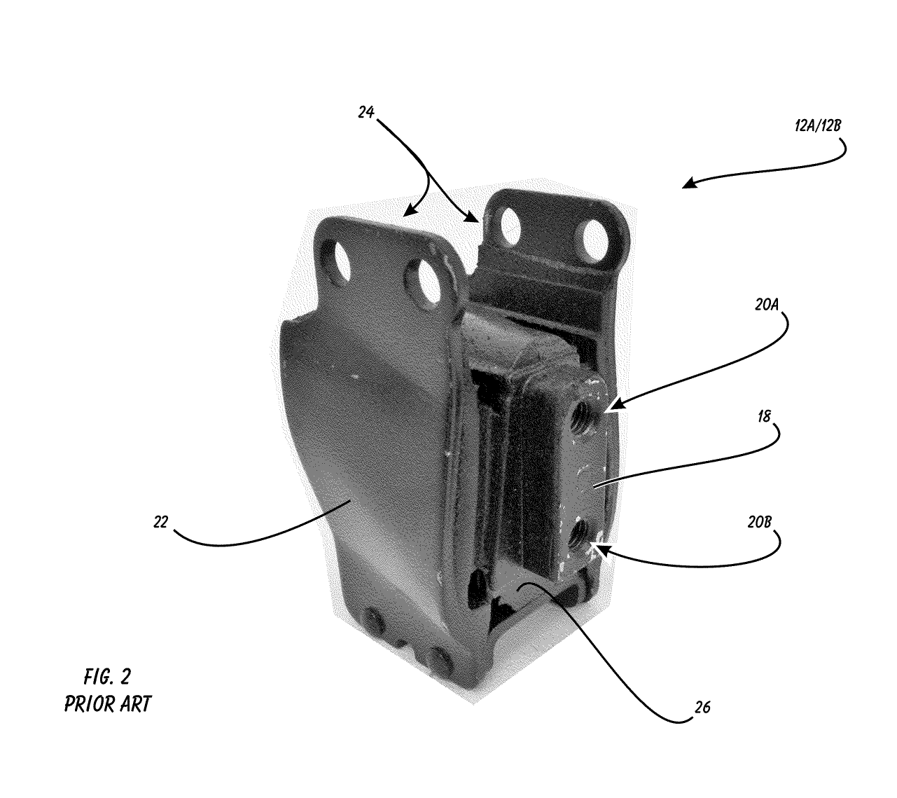

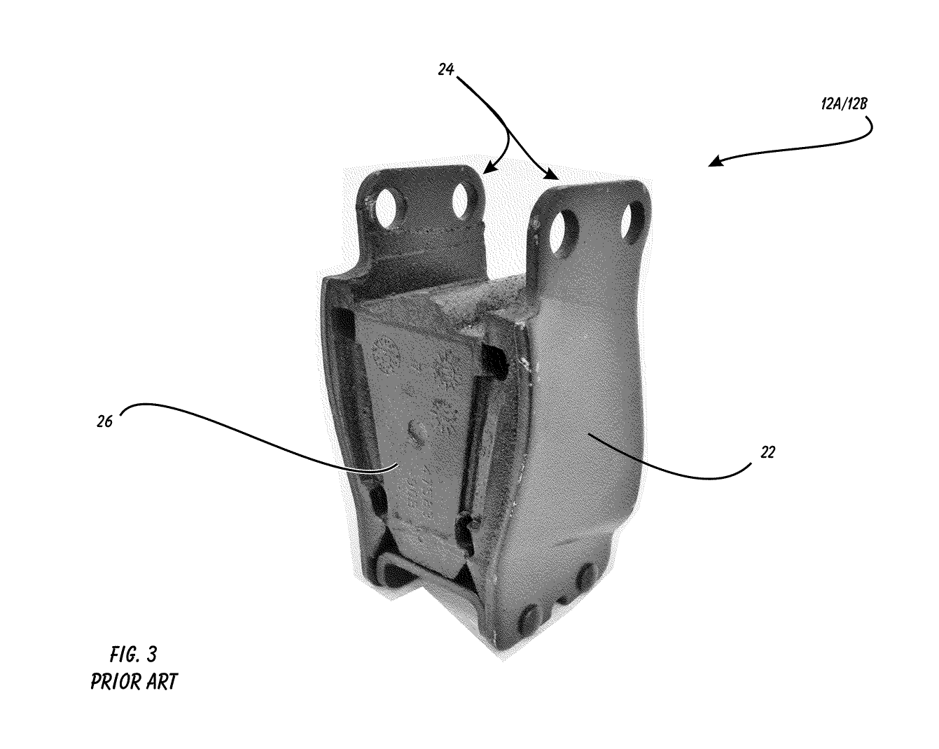

We will begin the description of the invention by first examining the features of the prior art Harley Davidson FXD_series motorcycle. FIG. 1 is a perspective view of the Harley Davidson FXD_series frame and engine mount assembly 10. In order to isolate and dampen the vibrations generated by the running engine, the engine (not shown) is linked to the frame 11 by a pair of engine mount elements 12A, 12B. Each mount 12A, 12B attaches to the frame 11 by a pair of frame bolts 14A, 14B (only shown for the rear engine mount element 12B). The engine (not shown) then attaches to each of the mounts 12A, 12B by a pair of engine bolts 16A, 16B. As will be discussed in connection with FIGS. 2 and 3, there is a rubber portion separating the frame bolts 14A, 14B from the engine bolts 12A, 12B. It is this rubber (provided for vibration dampening) that is insufficiently stiff, and therefore allows for unacceptable amounts of wobbling or shaking in the motorcycle under certain riding conditions.

FIG. 2 is a front perspective view of the conventional engine mount element 12A, 12B for an FXD_series Harley Davidson motorcycle. The outer structure is an engine attachment frame 22. This frame 22 is made from stamped steel, presumably for its durability. In this version, there are three individual pieces of stamped steel that have been riveted together. Captured inside of the engine attachment frame 22 is a frame attachment base 18. The frame attachment base 18 has a pair of threaded bolt bores 20A, 20B formed within it. These bores 20A, 20B are adapted to accept the frame bolts [14A, 14B] within them when the mount element 12A/12B is attached to the frame [11].

The engine bolt bores 24 are provided to accept engine bolts [16A, 16B] through them as they pass through corresponding bores formed in the engine (for mounting the engine to the mounting element 12A, 12B.

The problem area with the conventional engine mount elements 12A, 12B, lies with the rubber interstitial element 26. This rubber “fills” the gap between the engine attachment frame 22 and the frame attachment base 18. The rubber interstitial element 26 serves to prevent vibrations from being transmitted between the frame attachment base 18 and the engine attachment frame 22. By design, the rubber element 26 also secures and supports the frame attachment base 18 within the engine attachment frame 22.

The problem with the conventional mount elements 12A, 12B is that after very little time in service, this rubber interstitial element 26 becomes pliable and the frame attachment base 18 is no longer held securely within the engine attachment frame 22. The movement allowed between these elements results in a loose connection between the engine and the frame [11], which causes the wobbling under many riding conditions.

FIG. 3 is a rear perspective view of the engine mount element of FIG. 2. This view is provided to illuminate the fact that the back of the frame attachment base [18] does not protrude through the rubber interstitial element 26, but rather is fully encased in rubber (on three sides). As will be discussed below, this design error has been corrected with the device of the present invention.

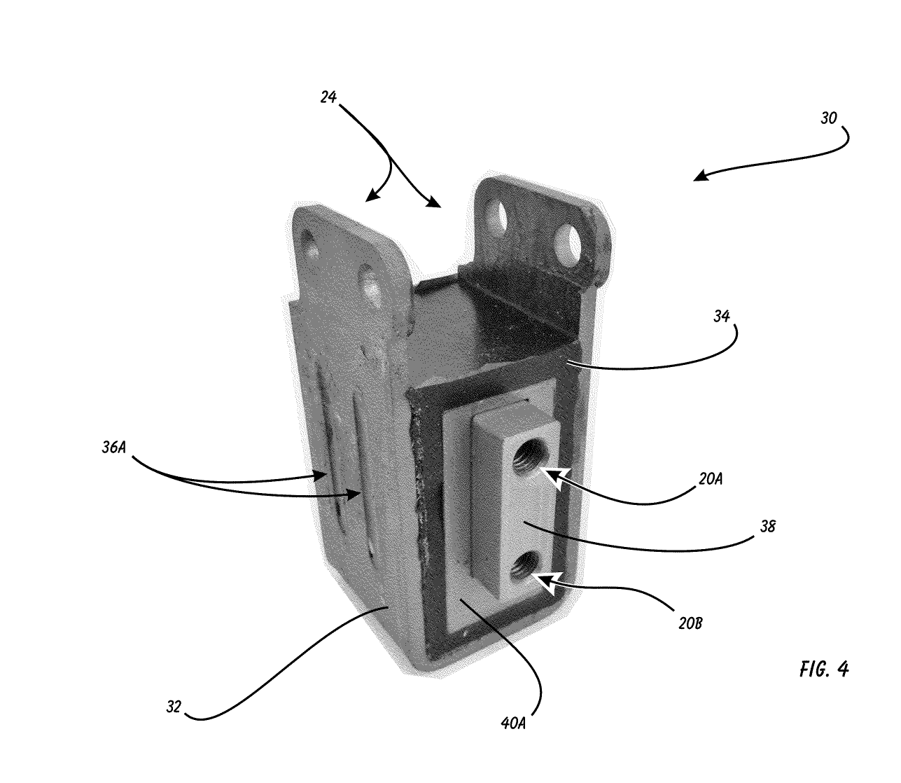

The present invention can best be understood by consideration of FIG. 4. FIG. 4 is a front perspective view a preferred embodiment of the engine mount element having improved stiffness 30 of the present invention. Of course, the improved mount element 30 is designed to fit the frame [11] perfectly as a replacement for the conventional mounts [12A, 12B]. It is there that the similarities end between the two designs, as will become clearer below.

The improved mounting element 30 has a one-piece engine attachment frame 32. It is formed from a single piece of hardened steel in order to ensure that there is virtually no degradation (i.e. deformation) after prolonged service time. The frame attachment element 38 protrudes from the mount element 30 just as with the prior design, and furthermore has the pair of threaded frame bolt bores 20A, 20B formed within it.

The interstitial element 34 in this mount 30 is made from a high quality urethane, instead of the rubber material used in the prior design. The urethane material 34 has superior wear performance as compared to rubber (i.e. it remains stiff much longer), and this particular urethane has been selected to have a durometer reading (A scale) of between 40 and 60 (A scale). It is preferred that the front mount [12A] urethane have a 45 durometer reading, and the rear mount [12B] urethane have a 55 durometer reading.

Two key additional features can be seen in this view—first, the engine attachment frame 32 is formed with retaining apertures 36A formed in it (there are actually five in the entire frame 32). Each retaining aperture (e.g. 36A) is designed to allow the urethane forming the interstitial material 34 to push out and fill in the aperture 36A. Once cured, this protruding material will form a secure bond between the interstitial element 34 and the engine attachment frame 32.

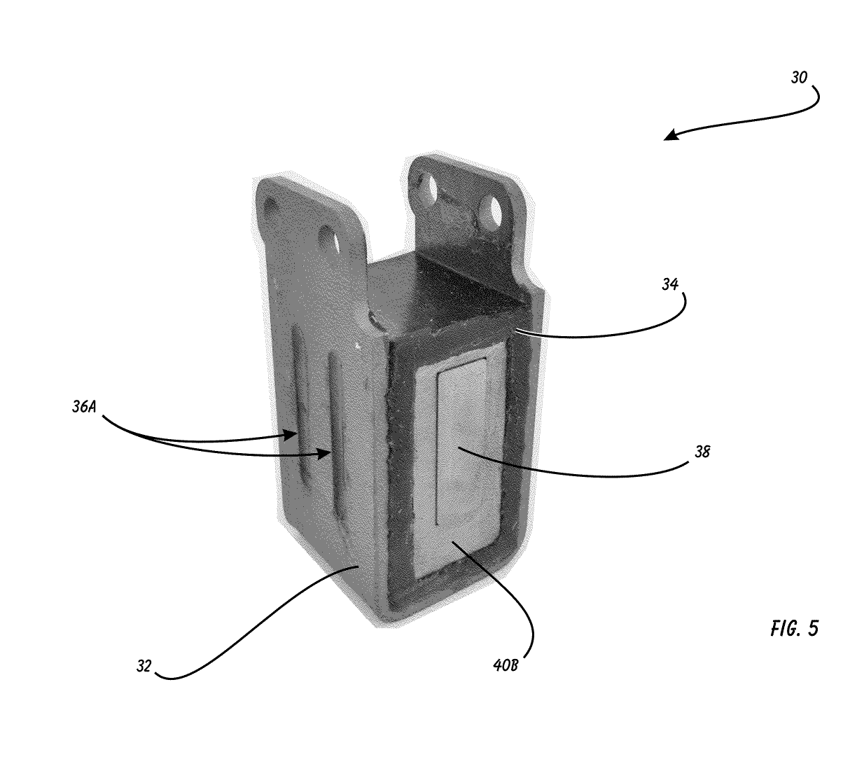

A second feature seen here is the inclusion of the front retention plate 40A. As shown, the head of the frame attachment element 38 protrudes through an aperture formed in the front retention plate 40A. The retention plate 40A serves to further bond with the interstitial element 34, while also stabilizing the restraining the frame attachment element 38 within the engine attachment frame 32. These two features, when combined with the use of urethane instead of rubber, serve to make the engine mount 30 substantially more durable and long-lasting. FIG. 5 shows the other side of the mount 30.

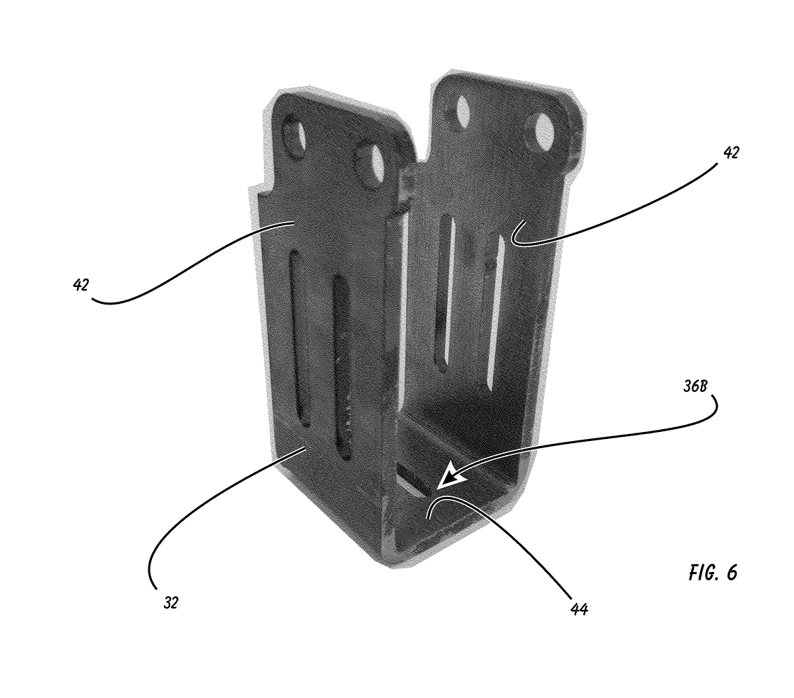

FIG. 5 is a rear perspective view of the element 30 of FIG. 4. In this view, the urethane of the interstitial element 34 can be seen protruding into the pair of retaining apertures on this (opposing) side of the engine attachment frame 32. The frame attachment element 38 actually protrudes from the back side of the urethane interstitial element 34. Like the other end of the frame attachment element 38, the rear retention plate 40B is embedded in the urethane material in order to firmly secure the element 38 within the urethane. FIG. 6 provides additional detail.

FIG. 6 is a front perspective view of the engine attachment frame 32 of the engine mount element [30] of FIGS. 4 and 5. As can be seen, the frame 32 is formed from a single piece of hardened steel that has been cut and then bent into shape. As a result, there are no mechanical connectors between components of the frame 32—it is a single unitary piece.

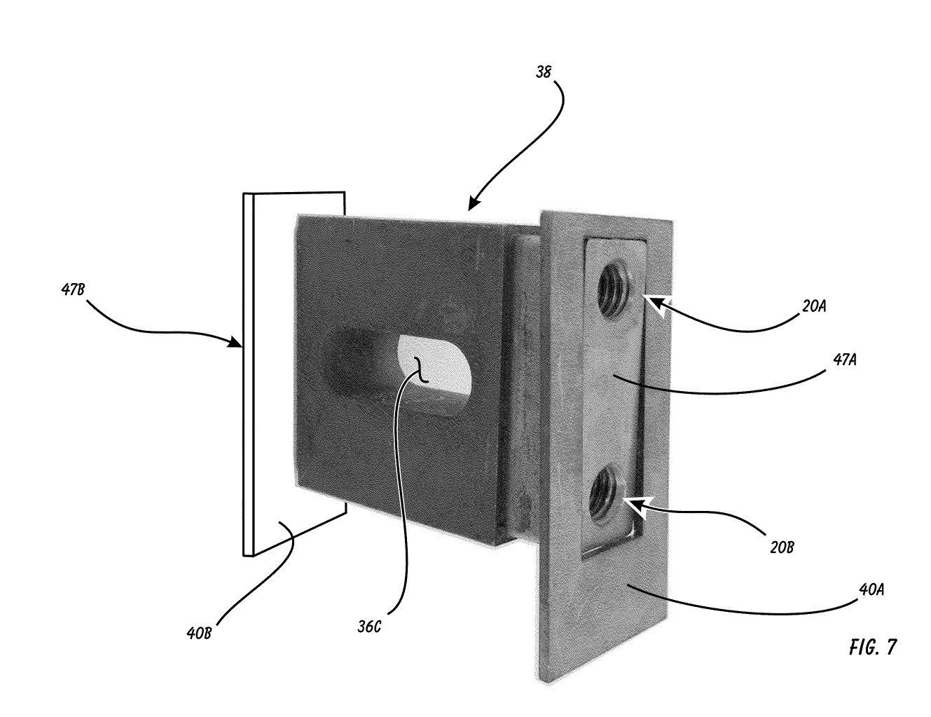

As can be seen, each sidewall 42 has a pair of retaining apertures formed completely through them. The bottom wall 44 has an additional retaining aperture 36B formed through it as well. As mentioned, when the urethane material is injected into the interstitial space between the frame attachment element [38] and the engine attachment frame 32, it will also fill in the area within these apertures 36A and 36B. Finally, we will turn to FIG. 7 to examine the final details of this useful device.

FIG. 7 is a front perspective view of the frame attachment element 38 and retention plates 40A, 40B of the element [30] of FIGS. 4 and 5. The element 38 is formed from a solid piece of steel, and has a retaining aperture 36C formed through it. This aperture 36C, like those previously discussed, fills with urethane when this material is injected into the interstitial space, and when cured, holds the element 38 firmly within the block of urethane.

At the front and rear faces 47A, 47B of the frame attachment element 38 are formed with an adjacent shoulder 46. The shoulder cooperates with the apertures cut into the front and rear retention plates 40A, 40B, so that the faces 47A, 47B are virtually flush with the outer surfaces of the retention plates 40A, 40B when the device [30] is fully assembled.

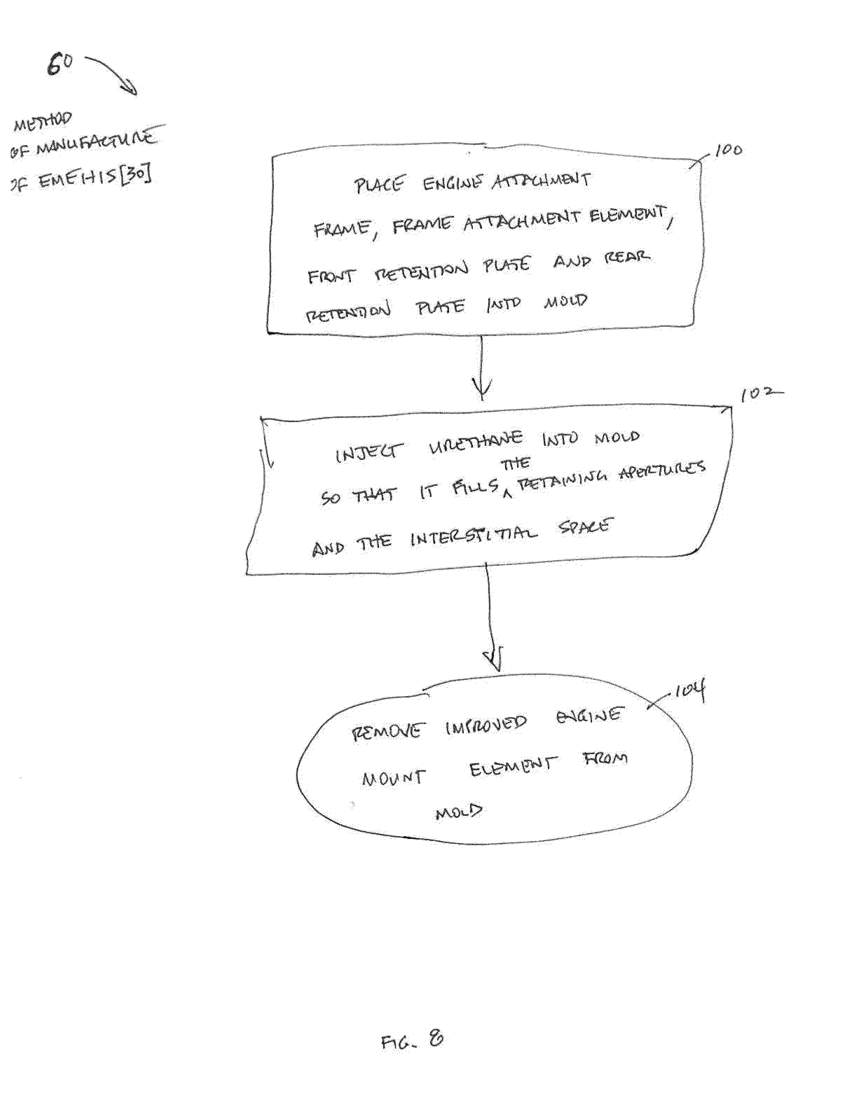

FIG. 8 is provided in order to more fully illuminate the device of the present invention. FIG. 8 is a flowchart depicting a preferred method of manufacture 60 of the engine mount element [30]. First 100, the engine attachment frame [32] is placed into the mold cavity. The frame attachment element [38], front retention plate [40A] and rear retention plate [40B] are placed into the engine attachment frame [32] so that they are in spaced relation to the frame [32].

Next, the preferred urethane material is injected into the space between the engine attachment frame [32] and the other elements [38, 40A, 40B] 102. As discussed above, the preferred urethane material will have an A-scale durometer hardness reading of between 40 and 60, depending upon whether it is being made as a mount element for the front of the engine or for the rear of the engine. When the material is injected, it is intentionally injected so that it fills the retaining apertures [36A, 36B] as well as the space between the frame [32] and the other elements [38, 40A, 40B].

Once the urethane material has sufficiently hardened, the engine mount [30] is removed from the mold 104.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A device for interconnecting an engine to a vehicle frame, the device comprising:
an engine attachment frame formed with two or more retaining apertures therethrough;
a frame attachment element located within said engine attachment frame in spaced relation thereto; and
an interstitial element interconnecting said engine attachment frame and said frame attachment element and further filling said retaining apertures.

2. The device of claim 1, wherein said interstitial element comprises material having an A-scale durameter hardness rating of between 40 and 40.

3. The device of claim 2, wherein said engine attachment frame is defined by a first side wall, a bottom wall and a second side wall, and wherein said frame is fabricated from a single piece of metal.

4. The device of claim 3, further comprising a front retention plate, and wherein:
said frame attachment element is defined by a front portion that partially protrudes through an aperture formed in said front retention plate;
said interstitial element interconnects said front retention plate to said engine attachment frame; and
said interstitial element does not contact said partially protruding front portion of said frame attachment element.

5. The device of claim 4, further comprising a rear retention plate, and wherein:
said frame attachment element is defined by a rear portion that partially protrudes through an aperture formed in said rear retention plate;
said intersitial element interconnects said front retention plate to said engine attachment frame; and
said interstitial element does not contact said partially protruding rear portion of said frame attachment element.

6. The device of claim 5, wherein said front portion of said frame attachment element is defined by a face having a pair of frame bolt bores formed therethrough into said frame attachment element, said frame bolt bores defined by threads formed along their walls.

7. The device of claim 6, wherein each said side wall of said engine attachment frame is defined by an upper portion terminating in a pair of engine bolt bores formed therethrough, wherein each said upper portion is not in contact with said interstitial element.

8. The device of claim 7, wherein each said side wall and said bottom wall is defined by at least one said retaining aperture formed therethrough

9. A method for manufacturing an engine mounting device, comprising the steps of:
placing an engine attachment frame into a mold cavity, said engine attachment frame defined by opposing side wall elements interconnected by a bottom wall element, and said engine attachment frame wall elements have one or more retaining apertures formed therethrough;
placing a frame attachment element into said mold cavity in spaced relation to said engine attachment frame wall elements;
injecting interstitial material into said space between said frame attachment element and said engine attachment frame such that it fills said space as well as said retaining apertures;
waiting for said injected interstitial material to harden sufficiently to form an interstitial element; and
removing said engine mounting device, defined by said engine attachment frame, said frame attachment element and said interstitial element, from said mold cavity.

10. The method of claim 9, further comprising a front retention plate placing step prior to said frame attachment element placing step, said front retention plate placing step comprising placing a front plate on said frame attachment element such that a front portion of said frame attachment element protrudes through an aperture formed in said front plate.

11. The method of claim 10, further comprising a rear retention plate placing step prior to said frame attachment element placing step, said rear retention plate placing step comprising placing a rear plate on said frame attachment element such that a rear portion of said frame attachment element protrudes through an aperture formed in said rear plate.

12. The method of claim 9, wherein said material injecting step comprises injecting material having an A-scale durometer hardness reading of between 40 and 60 once said material has fully hardened.

13. The method of claim 10, wherein said material injecting step comprises injecting material having an A-scale durometer hardness reading of between 40 and 60 once said material has fully hardened.

14. A motorcycle engine mount assembly for interconnecting an engine to a motorcycle frame, comprising:
an engine attachment frame formed with two or more retaining apertures therethrough;
a frame attachment element located within said engine attachment frame in spaced relation thereto; and
an interstitial element interconnecting said engine attachment frame and said frame attachment element and further filling said retaining apertures.

15. The assembly of claim 14, further comprising a front retention plate, and wherein:
said frame attachment element is defined by a front portion that partially protrudes through an aperture formed in said front retention plate;
said interstitial element interconnects said front retention plate to said engine attachment frame; and
said interstitial element does not contact said partially protruding front portion of said frame attachment element.

16. The assembly of claim 15, further comprising a rear retention plate, and wherein:
said frame attachment element is defined by a rear portion that partially protrudes through an aperture formed in said rear retention plate;
said intersitial element interconnects said front retention plate to said engine attachment frame; and
said interstitial element does not contact said partially protruding rear portion of said frame attachment element.

17. The assembly of claim 16, wherein said engine attachment frame is defined by a first side wall, a bottom wall and a second side wall, and wherein said frame is fabricated from a single piece of metal.

18. The assembly of claim 17, wherein said interstitial element comprises material having an A-scale durameter hardness rating of between 40 and 40.

19. The assembly of claim 18, wherein said front portion of said frame attachment element is defined by a face having a pair of frame bolt bores formed therethrough into said frame attachment element, said frame bolt bores defined by threads formed along their walls.

20. The assembly of claim 19, wherein each said side wall and said bottom wall is defined by at least one said retaining aperture formed therethrough
